(19) United States
(12) Patent Application Publication
(10) Pub. No.: US 2003/0007471 A1
(43) Pub. Date: Jan. 9, 2003

(54) Operation of wideband code division multiple access base stations

(76) Inventors: Daisuke Terasawa, San Diego, CA (US); Avneesh Agrawal, San Jose, CA (US)

Correspondence Address: QUALCOMM Incorporated, Attn: Patent Department, 5775 Morehouse Drive, San Diego, CA, 92121-1714, US

(21) Appl. No.: 09/929,557

(22) Filed: Aug. 13, 2001

Related U.S. Application Data
(60) Provisional application No. 60/303,021, filed on Jul. 3, 2001.

(51) Int. Cl. H04B 7/216

(52) U.S. Cl. 370/335; 370/503

(57) ABSTRACT

A wideband code division multiple access system supports asynchronous operation, with each base station having its own time reference. Substantial benefits may be realized by operating the WCDMA system in a quasi-synchronous mode, in which the base stations broadcast the relative time difference between their time references and the time references of their neighbor base stations. The WCDMA system supports techniques for measuring the relative time difference.

### RELATED APPLICATIONS

This application claims priority to U.S. Provisional Application No. 60/303,021, filed Jul. 3, 2001.

### FIELD

The invention relates to communication systems. More particularly, the invention relates to time references employed by base stations in a system employing wideband code division multiple access (WCDMA) techniques.

### BACKGROUND

Wireless communication systems are widely deployed to provide various types of communication such as voice, data, and so on. These systems may be based on code division multiple access (CDMA), time division multiple access (TDMA), or some other modulation and multiple access techniques. A CDMA system provides certain advantages over other types of systems, including increased system capacity.

A CDMA system may be designed to support one or more CDMA standards such as (1) the “TIA/EIA-95-B Mobile Station-Base Station Compatibility Standard for Dual-Mode Wideband Spread Spectrum Cellular System” (the IS-95 standard), (2) a companion to the IS-95 standard, the “TIA/EIA-98-C Recommended Minimum Standard for Dual-Mode Wideband Spread Spectrum Cellular Mobile Station” (the IS-98 standard), (3) the standard offered by a consortium named “3rd Generation Partnership Project 2” (3GPP2) and embodied in a set of documents including Document Nos. 3G TS 25.211, 3G TS 25.212, 3G TS 25.213, and 3G TS 25.214 (the WCDMA standard), (4) the standard offered by a consortium named “3rd Generation Partnership Project 2” (3GPP2) and embodied in a set of documents including “TR-45.5 Physical Layer Standard for cdma2000 Spread Spectrum Systems,” the “C.S0005-A Upper Layer (Layer 3) Signaling Standard for cdma2000 Spread Spectrum Systems,” and the “C.S0024 cdma2000 High Rate Packet Data Air Interface Specification” (the cdma2000 standard), and (5) some other standards. A system that implements the High Rate Packet Data specification of the cdma2000 standard is referred to herein as a high data rate (HDR) system. The HDR system is documented in TIA/EIA-IS-856, “CDMA2000 High Rate Packet Data Air Interface Specification.” Proposed wireless systems also provide a combination of HDR and low data rate services (such as voice and fax services) using a single air interface.

In the development of third generation systems, cdma2000 and WCDMA, both CDMA systems, have emerged as competing technologies. Like earlier generations of CDMA, cdma2000 and WCDMA support soft handover. In soft handover, a mobile station such as cellular phone communicates via two or more base stations at one time. Soft handover is a prerequisite for efficient operation of a CDMA system. Techniques available for making soft handover depend upon the synchronization of base stations in the system. Cdma2000 was an evolution from IS-95, and like its predecessor, relies primarily on the global positioning system (GPS) to provide a timing reference for inter-base station synchronization.

WCDMA provides for a way to operate the network without synchronizing all the base stations. An asynchronous approach is said to overcome certain deployment challenges such as that for in-building deployment or dense urban areas. It also helps ease the concern of some regulators who preferred not to rely on GPS as a timing reference.

In a WCDMA system, base stations use different long PN codes. The base stations rely on these different long codes to distinguish themselves. WCDMA base stations therefore do not need a common time reference and may operate asynchronously. IS-95 and cdma2000 systems, by contrast, use time-offset versions of a single code.

In a synchronous CDMA system, all base stations have to be synchronized for correct operation, and each mobile station in communication with a base station synchronizes with the base station. When the base stations are synchronized with each other, it is relatively straightforward for the mobile station to synchronize with another base station when entering soft handover. In the case of an asynchronous system, like WCDMA, synchronization with another base station is less straightforward and requires the mobile station to do more work.

With asynchronous deployment, the mobile station has no knowledge about the PN code phase of any of the neighboring base stations. To acquire the timing of these base stations, the mobile station searches the entire range of possible PN code phases for each base station, which is a time-consuming process. In regions such as dense urban areas where cells tend to be smaller and the number of neighboring base stations is large, the process can be prohibitively time-consuming.

One disadvantage of asynchronous operation, therefore, is increased search time. Search time includes the time needed by the mobile station to detect a base station and, upon detection, to ascertain the strength and timing of the base station. When a mobile station acquires the code and frame timing of a base station, the base station may be included in the “active set” of the mobile station. A mobile station communicates with all base stations in the active set.

Various approaches to providing synchronization in WCDMA have been proposed. One such “quasi-synchronization” approach involves the radio network controller having the base stations adjust (slew) their timing clocks as a function of (i) time of receipt measurements transmitted by an individual mobile, and (ii) the associated relevant round trip delay (RTD) calculations.

A “quasi-synchronization” approach that does not require base stations to adjust their timings may be preferable.

### SUMMARY

A quasi-synchronous operation for WCDMA is described. In one embodiment, each base station in the system has an independent time reference and the relative time difference between the time references of neighbor base stations is measured. This relative time difference is broadcast to the mobile stations to provide more accurate timing references to the mobile stations.

When the base stations are quasi-synchronized in this way, system performance improves. System performance is a function of mobile station search time, and search time is significantly reduced, particularly with regard to soft handovers.

For simplicity, the techniques described below will be presented in the context of a mobile station in communication with two base stations, i.e., the mobile station is communicating via both the first and second base stations at the same time. When a mobile station is performing a soft handover with, for example, two base stations, the mobile station sends both base stations a measurement report message. The measurement report message, which is unnoticed by the user of the mobile station, includes information such as the timing of reception of signals transmitted from base stations. In a soft handover scenario, the mobile station receives an identical data stream twice, once from each base station. Although each base station transmits the same data stream, each base station spreads the data stream with a different long PN code. Each base station also includes in its transmission data related to maintenance of the communication link, which is unnoticed by the user of the mobile station.

In most instances, there will be a time delay between receiving the data stream from one base station and receiving the same data stream from the other base station. This time delay is reported by the mobile station to a radio network controller (RNC) via both base stations in the measurement report message. The RNC controls the operations of the base stations.

In a soft handover scenario, the mobile station receives downlinks from two base stations, and transmits uplinks to both base stations. The mobile station, however, adjusts the timing of its uplinks to the timing of the downlinks from only one of the base stations. Both base stations receive the uplink. Each base station notes the delay between the time the downlink was sent and the time the uplink was received.

Three delays can be measured. Each base station measures the time delay between transmission of a downlink and receipt of an uplink. The mobile station measures the time delay between receiving the data stream from one base station and receiving the same data stream from the other base station. From these measured delays, the RNC calculates the relative time difference between the two base stations.

Once the relative time difference is known, the base stations may be placed in quasi-synchronous operation. In quasi-synchronous operation, each base station in the system retains its independent time reference. Each base station, however, broadcasts the relative time difference between its own time reference and the time references of its neighbor base stations.

The performance of a WCDMA system deployed quasi-synchronously is better than the performance of a WCDMA system deployed asynchronously, in many respects. The search space, which includes the searching by a mobile station to acquire the timing of a base station or vice versa, is substantially less in a quasi-synchronous deployment. A quasi-synchronous WCDMA system also has an enhanced system capacity, in comparison to a comparable WCDMA system operating asynchronously.

The above summary of the invention is not intended to describe every embodiment of the invention. The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a diagram showing a mobile station in communication with neighboring base stations in a WCDMA system.

FIG. 2 is a timing diagram illustrating measured timing parameters.

FIG. 3 is a flow diagram for quasi-synchronous operation of base stations in a WCDMA system.

FIG. 4 is a flow diagram illustrating soft handover in quasi-synchronous operation of base stations in a WCDMA system.

### DETAILED DESCRIPTION

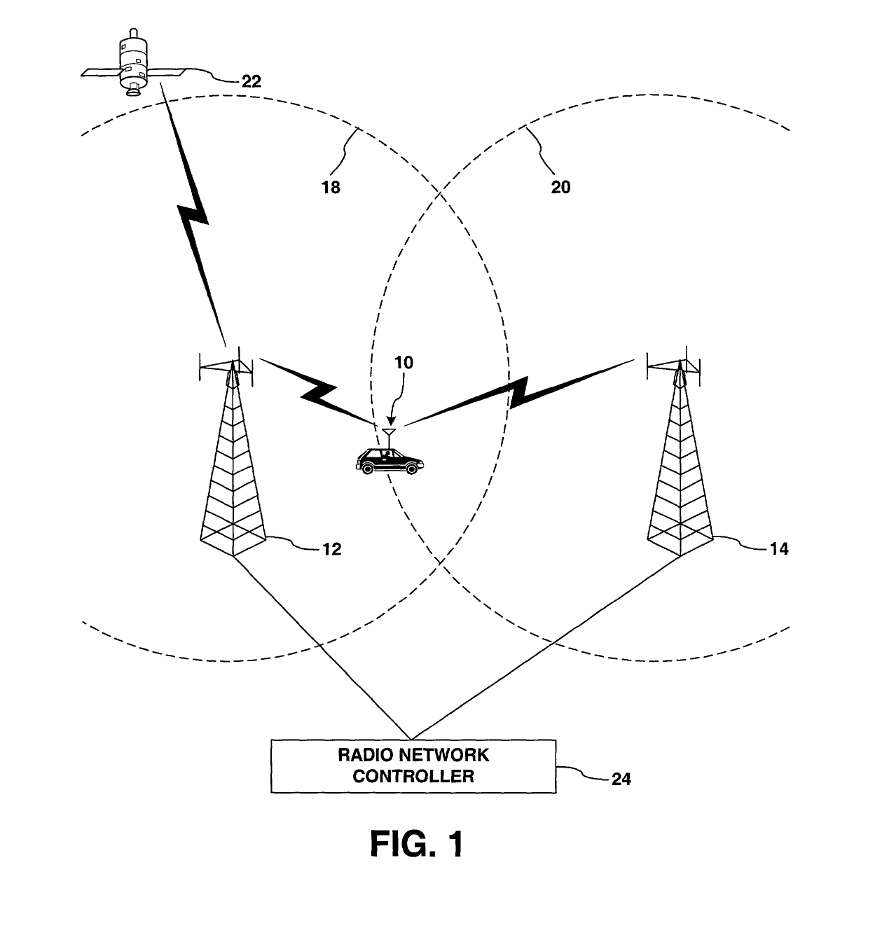

FIG. 1 represents a WCDMA system, in which a mobile station 10 communicates with neighboring base stations 12 and 14, both of which are in the active set of mobile station 10. Mobile station 10 is in soft handover wireless communication with base station 12 and base station 14 and is within the coverage areas delineated by base station coverage boundaries 18 and 20. Base stations 12 and 14 are said to be “neighbors” because their coverage areas allow a mobile station such as mobile station 10 to establish a communication link with both base stations 12 and 14 simultaneously.

For simplicity, mobile station 10 is shown communicates via two base stations 12 and 14. It is possible for mobile station 10 to be communicating via more than two base stations. In addition, base stations 12 and 14 are depicted for simplicity as omnidirectional. In a WCDMA system, a single base station may divide its coverage area into sectors, and may direct different transmissions to each sector. The techniques described herein may be applied to WCDMA systems in which base stations divide coverage areas into sectors.

While in soft handover communication, mobile station 10 is redundantly in wireless communication with both base stations 12 and 14 for some period of time. Soft handover is contrasted with hard handover, in which the wireless communication link between base station 12 and mobile station 10 is broken before the wireless communication link between base station 14 and mobile station 10 is established.

Base station 12 and base station 14 are coupled to RNC 24 which controls the operations of base stations 12 and 14. Although base station 12 and base station 14 are shown sharing RNC 24, neighboring base stations may employ different radio network controllers in some circumstances.

RNC 24 may include interfaces to other communications systems. For example, RNC 24 may be connected to the public switched telephone network (PSTN) via a mobile switching center (not shown in FIG. 1). RNC 24 may route calls from the PSTN to base stations 12 and 14 via a T1 line or other means. RNC 24 also controls which base stations are in the active set of mobile station 10, and routes communications to mobile station 10 via the base stations in the active set. During a soft handover, the same data streams may be transmitted from base stations 12 and 14 simultaneously, although base stations 12 and 14, operating asynchronously, do not necessarily transmit the data stream at exactly the same time.

Each base station 12 and 14 has an independent timing reference. Base station 12 obtains its timing reference from global positioning system 22 (GPS), but base station 14 does not obtain its timing reference from GPS 22. In a typical WCDMA system, each base station may have several neighbors and each base station may have an independent time reference. In WCDMA, it is not necessary for neighbor base stations to have the same timing reference.

Although a WCDMA system may operate asynchronously, the system supports quasi-synchronous operation. In quasi-synchronous operation, each base station has its own time reference, but each base station also keeps track of the relative time differences between itself and its neighbor base stations, i.e., the time offsets between the base station's own time reference and the time references used by its neighbor base stations. Each base station broadcasts the relative time difference information to mobile stations within its coverage area. As will be shown below, quasi-synchronous operation offers advantages over asynchronous operation.

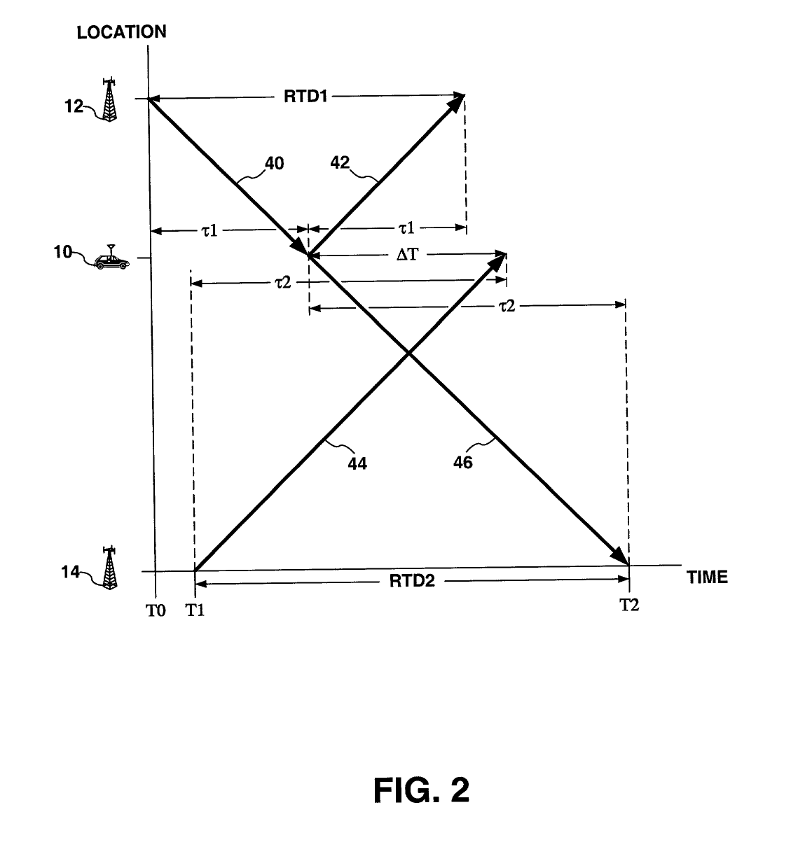

To achieve quasi-synchronous operation, the relative time differences between the base stations are measured. FIG. 2 is a timing diagram that illustrates techniques for measuring timing differences in a soft handover situation. The horizontal axis represents time and the vertical axis shows relative distance among base station 12, mobile station 10 and base station 14. Just as in FIG. 1, mobile station 10 is closer to base station 12 than to base station 14.

A downlink signal is transmitted by base station 12 and a related downlink signal with an identical data stream is transmitted by base station 14. Base station 12 transmits the downlink signal at time T0, and base station 14 transmits the related downlink signal at time T1. When base stations 12 and 14 are synchronized, T0 and T1 are equal. When base stations 12 and 14 are not synchronized, however, the difference between T1 and T0 is a function of the relative time difference between the base stations.

The downlink signal may be identified with a system frame number (SFN), which identifies the time window in which the downlink was transmitted. The data stream in the downlink signal is received twice by mobile station 10 at different times. During the time window, base stations 12 and 14 transmit a downlink to mobile station 10, and mobile station 10 transmits an uplink to base stations 12 and 14.

Signal path 40 represents the transmission of a downlink signal from base station 12 to mobile station 10. The time interval over which this transmission occurs is designated as T1. At mobile station 10, the start of frame transmissions on the uplink are time aligned with the start of frame arrivals on the downlink. The start of frame transmissions on the uplink may also be time aligned with the start of frame arrivals on the downlink, plus a known time delay. For simplicity, this known time delay is omitted from FIG. 2.

Signal path 42 depicts the transmission of an uplink frame from mobile station 10 to base station 12. The time for this signal to travel from mobile station 10 to base station 12 is approximately the same as the time interval for the downlink, τ1.

Mobile station 10 may be in motion relative to base station 12, and consequently the time needed for downlink signal path 40 may not be exactly the same as the time needed for uplink signal path 42. The time discrepancy, however, is usually not substantial. In addition, the measurements described below may be taken with respect to several mobile stations and may be averaged or otherwise processed to disregard a time discrepancy caused by the motion of a particular mobile station such as mobile station 10.

At base station 12, the time that the downlink was sent, T0, is noted, as is the time that the uplink was received. RNC 24 takes the difference between these two times to obtain a round-trip delay designated RTD1. RTD1 is equal to twice τ1, so τ1 is half of RTD1. If the uplink is preceded by a known time delay, RNC 24 subtracts the known time delay from the measured time delay to obtain τ1 and RTD1.

Base station 14 likewise transmits a downlink, which follows signal path 44. At base station 14, the time that the downlink was transmitted, T1 is noted. When mobile station 10 transmits the uplink, mobile station 10 transmits the uplink both to base station 12 and to base station 14. Accordingly, the uplink follows signal path 46 to base station 14, arriving at time T2. RNC 24 takes the difference between T2 and T1, which is designated RTD2.

The time taken for the signal to travel from base station 14 to mobile station 10 on the downlink is designated τ2. τ2 is also the time taken for the signal to travel from mobile station 10 to base station 14 on the uplink. As shown by FIG. 2, however, τ2 is not equal to half of RTD2.

Mobile station 10 receives the same data stream twice. Mobile station 10 receives the data stream via signal path 42 from base station 12 first. Mobile station 10 receives the data stream via signal path 44 from base station 14 at a later time. By noting the times that mobile station 10 receives the same data stream from base stations 12 and 14, a time difference ΔT can be ascertained. Mobile equipment may include the measurement of ΔT in a measurement report, which is transmitted to RNC 24 via base stations 12 and 14.

The following factors have thus been measured and are known to RNC 24: RTD1, RTD2, and ΔT. The goal is to calculate T1−T0, which represents the relative time difference between base stations 12 and 14.

From FIG. 2, it may be observed that:

T2−T0=τ1+τ2 (1)

τ1+ΔT=1−T0+τ2 (2)

Adding equations (1) and (2), canceling terms and rearranging leads to:

T2+ΔT=T1+2(τ2) (3)

2(τ2)=ΔT+T2−T1 (4)

The difference T2−T1 is equal to RTD2, so:

2(τ2)=ΔT+RTD2 (5)

τ2=(ΔT)/2+(RTD2)/2 (6)

Rearranging equation (2), recalling that RTD1 equals twice τ1, substituting and simplifying yields:

T1−T0=τ1−τ2+ΔT (7)

T1−T0=(RTD1)/2−[(ΔT)/2+(RTD2)/2]+ΔT (8)

T1−T0=(RTD1)/2−(RTD2)/2+(ΔT)/2 (9)

T1−T0=(RTD1−RTD2+ΔT)/2 (10)

In this way, measurements of RTD1, RTD2, and ΔT may be used by RNC 24 to calculate the relative time difference between base stations 12 and 14. Once the relative time difference is known, RNC 24 relays this information to base stations 12 and 14, which may use the information to support quasi-synchronous operation.

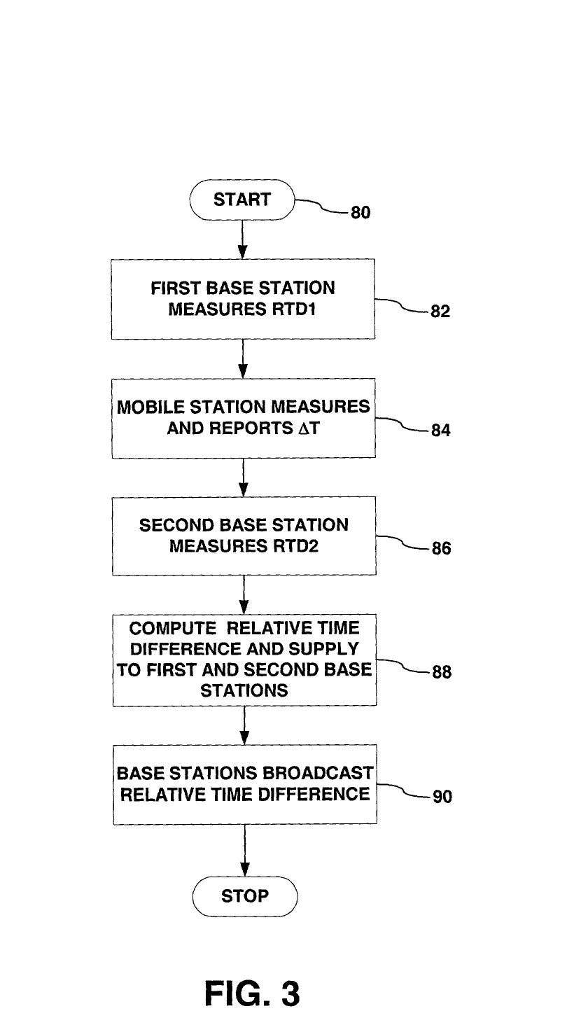

FIG. 3 is a flow diagram illustrating the use of the relative time difference to place two base stations, such as base stations 12 and 14, in quasi-synchronous operation. In quasi-synchronous operation, each base station employs a timing reference that is independent of other base stations.

As quasi-synchronization begins (80), mobile station 10 is in communication with first base station 12 and within range to conduct communications with second base station 14. It is assumed that mobile station 10 is time aligned with first base station 12. RTD1 is measured at first base station 12 (82) by measuring the difference between the time a downlink was sent and the time a corresponding uplink was received.

As noted above, mobile station 10 aligns the frame boundaries of frames being received by mobile station 10 with the frame boundaries of frames transmitted by mobile station 10. In other words, mobile station 10 synchronizes its transmissions to the time reference of first base station 12. RTD1 is measured as the time difference between the start of frames transmitted by first base station 12 and the start of frames received by first base station 12 from mobile station 10. If the uplink is preceded by a known time delay, RNC 24 subtracts off the known time delay.

At some time ΔT after receiving the downlink from first base station 12, mobile station 10 receives a downlink for the same data stream transmitted by second base station 14. Once mobile station 10 receives the downlink transmitted by second base station 14, mobile station 10 computes and reports ΔT to RNC 24 in a measurement report (84).

Measurement reports are supported within the WCDMA protocol and may be transmitted by mobile station 10 at regular intervals, or may be transmitted upon the occurrence of trigger events. Some WCDMA RNC's may instruct mobile stations concerning when and how frequently measurement reports ought to be transmitted. Measurement reports typically include not only a measurement of ΔT but also other measurements of importance, such as the signal strength of one or more base stations as measured by mobile station 10.

The time between a downlink and uplink is measured at base station 14 as well. RNC 24 thereby measures RTD2 (86). If necessary, RNC 24 subtracts off the known time delay to obtain RTD2. When RNC 24 has measurements for RTD1, RTD2 and ΔT, RNC 24 calculates the relative time difference between base stations 12 and 14 according to equation (10) above, using a digital signal processing apparatus such as a computer. RNC 24 supplies the results of the computation to first and second base stations 12 and 14 (88). Alternatively, RNC 24 may supply the measurements for RTD2 and ΔT to first base station 12, and RTD1 and ΔT to second base station 14. Each base station may compute the relative time difference with its neighbor.

In practice, this technique may include repeated measurements of RTD1, RTD2 and ΔT for a single mobile station, as well as measurements of RTD1, RTD2 and ΔT for several mobile stations. The measurements and/or relative time differences may be averaged or otherwise processed to reduce time discrepancies caused by factors such as motion of mobile stations with respect to the base stations.

Alternatively, RNC 24 may calculate relative time difference between base stations using a simpler, yet less accurate, technique. In particular, RNC 24 assumes that mobile station 10 is equally distant from both base stations 12 and 14. With this assumption, the relative time difference between base stations 12 and 14 is simply AT. The measurements of ΔT for several mobile stations may be averaged or otherwise processed to reduce time discrepancies. The averaged value of ΔT may be supplied by RNC 24 to the base stations.

Base stations 12 and 14 then broadcast the relative time difference, which may be received by any mobile stations in their respective coverage areas (90). Base station 12 broadcasts the relative time difference between it and base station 14, and base station 14 broadcasts the relative time difference between it and base station 12. The relative time differences may be broadcast in units of seconds, chips or other convenient units, and may be positive or negative.

The WCDMA protocol supports the broadcast of relative time differences. Each base station broadcasts system information broadcast messages, which may include relative time differences with neighbor base stations in a “Reference Time Difference To Cell” field. The WCDMA protocol specified by the Third Generation Partnership Project (3GPP) includes provisions for reporting accuracies to within 40, 256 or 2,560 chips in the system information broadcast messages. Quasi-synchronization may therefore be implemented without modification to the 3GPP standard.

Quasi-synchronous deployment is more efficient than asynchronous deployment. With asynchronous deployment, the mobile station has no knowledge about the PN code phase of any of the neighboring base stations. To acquire the timing of these base stations, the mobile station must search the entire range of possible PN code phases for each base station, which is a time-consuming process. In regions such as dense urban area where cells tend to be smaller and the number of neighboring base stations is large, the process can be prohibitively time-consuming.

Each base station employs a primary scrambling code PN sequence chosen from among 512 truncated Gold code sequences that are periodic with a period of 38,400 chips, also called a “frame.” “Chips” may be thought of as units of time that are convenient for a WCDMA system. The duration of a chip duration is the minimum time between transitions of a PN code. In a WCDMA system, there are 38,400 chips per frame, with each frame transmitted over 10 ms. In other words, a WCDMA system supports a chip rate of 3.84 million chips per second, with the PN code repeating every 38,400 chips.). In such a system, one chip corresponds to 1/3,840,000 seconds or about 260.4 nanoseconds.

Before a mobile station can communicate with a base station, the mobile station must acquire the code and frame timing of the base station. Each base station broadcasts its primary scrambling code without any data modulation on a common pilot channel (CPICH). It is not practical for a mobile station to search through all 512 Gold codes for each of the 38,400 PN code phases, so the base station also transmits additional synchronization channels. The primary synchronization channel (PSC) is a fixed sequence that is transmitted once per 2,560 chips, referred to as a slot. In a frame of 38,400 chips, there are fifteen 2,560-chip slots. By searching for the PSC, the mobile station can acquire the slot timing.

After acquiring slot timing, the mobile station turns to the secondary synchronization channel (SSC), which transmits a sequence that allows the mobile station to uniquely identify frame timing and narrow the scrambling code down to a group of eight possibilities. After acquiring the SSC, the final step is to search the CPICH using the eight scrambling codes which one is actually in use by the base station.

In handover searching, each base station broadcasts the scrambling codes of its neighbor base stations. Even though the mobile station knows the scrambling codes of neighbor base stations, the mobile station still must still acquire the timing of the neighbor base stations before it can include the neighbor base stations in the active set. In an asynchronous deployment, the mobile station must perform a fresh search for each neighbor base station.

When base stations in a WCDMA system are quasi-synchronized, by contrast, the performance of the system is improved in several respects. Acquisition of multiple base stations by a mobile station is more efficient, because the mobile station does not need to repeat the entire time-consuming process of searching the entire range of possible PN code phases for each base station.

Instead, the mobile station uses data in its possession to narrow the search space and acquire the timing of the neighboring base station more quickly. In particular, the mobile station knows the timing for a first base station, because the mobile station is in communication with the first base station. In addition, the mobile station knows the relative time difference between the first base station and a neighbor base station, because the first base station broadcasts the relative time differences between itself and its neighbor base stations.

Knowing the timing of the first base station and the relative time difference between the first base station and the neighbor base station, the mobile station can calculate the timing of the neighbor base station, with an amount of uncertainty. The uncertainty is usually small enough that the amount of searching needed to acquire the timing of the neighbor base station is substantially reduced, as compared with the amount of searching needed when performing a fresh search. Typically, the uncertainty is so small that a PSC search is unnecessary, resulting in a considerable saving of time.

The uncertainty is a function of the coverage area of the neighbor base station. As noted above, 3GPP specifications allow for the uncertainty of a PN code phase to be specified as 40 chips, 256 chips or 2,560 chips. The smaller the cell, the less uncertainty. A cell having a coverage area radius of 1.5 km, for example, corresponds to a 40-chip uncertainty. A mobile station can acquire a neighbor base station quickly when the mobile station has only 40 chips to search. The uncertainty range in an asynchronous WCDMA system, by contrast, is 38,400 chips.

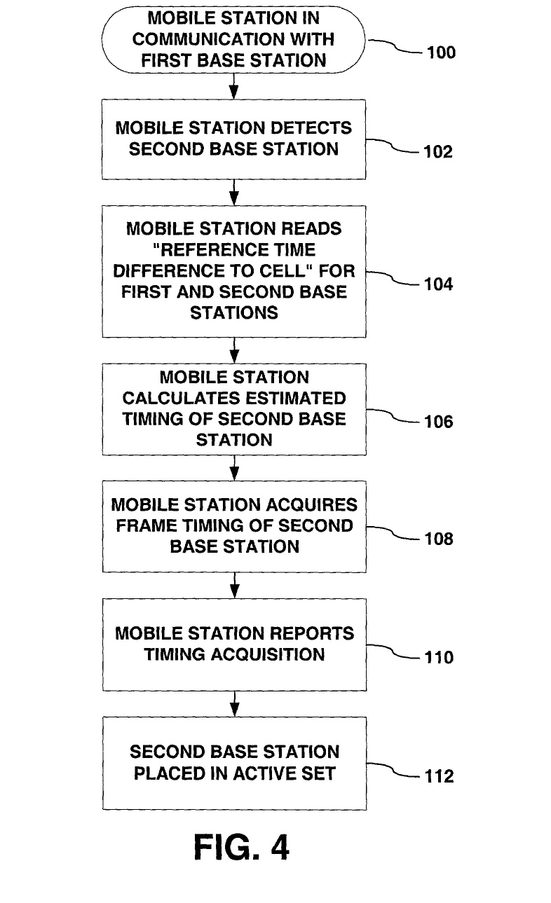

FIG. 4 illustrates a benefit of reduced search time in a WCDMA system deployed in a quasi-synchronous mode. Mobile station 10 is in wireless communication with first base station 12 (100) but not with second base station 14. As mobile station 10 nears second base station 14, mobile station 10 detects the increasing strength of the signal from second base station 14 (102).

Mobile station 10 proceeds to acquire the code and frame timing of second base station 14. Mobile station 10 acquires the code of base station 14 from a broadcast from base station 12, as first base station 12 broadcasts the scrambling codes of its neighbor base stations.

Mobile station 10 accesses system information broadcast messages transmitted by first base station 12, and in particular, mobile station 10 reads the relative time differences between first base station 12 and second base station 14 in a “Reference Time Difference To Cell” field in the system information broadcast messages (104). Mobile station 10 knows the timing of first base station 12 and further knows the relative time difference between first base station 12 and second base station 14. From this information, mobile station 10 calculates the timing of second base station 14 with some uncertainty (106) and acquires the timing of second base station 14 (108). Mobile station 10 informs RNC 24 that the timing of second base station 14 has been acquired (110), and may also report the signal strength of second base station 14. RNC 24 may then include second base station 14 in the active set of mobile station 10 (112) RNC 24 may relay data streams to mobile station 10 via base station 12 and base station 14. RNC 24 may further notify mobile station 10 that base stations 12 and 14 are in the active set, and mobile station 10 may receive data streams from and transmit data streams to both base stations.

As the signal from first base station 12 grows weaker and the signal from second base station 14 grows stronger, the chance of first base station 12 handing off to second base station 14 increases. Mobile station 10 may synchronize to second base station 14 and first base station 12 and mobile station 10 may break contact with each other. Alternatively, mobile station 10 may remain in soft handover with both base stations 12 and 14 indefinitely. While in communication with both first base station 12 and second base station 14, mobile station 10 may also measure and report ΔT in a measurement report, as described above.

A quasi-synchronous WCDMA system offers an improvement over an asynchronous WCDMA system because searches for neighboring base stations can be performed more quickly and more frequently. The capacity of the WCDMA system as a whole is improved when mobile stations can quickly detect strong neighbor base stations and include those base stations in the active set.

The reduced search spaces provided by quasi-synchronization benefit the base stations as well as the mobile stations. When a mobile station that in communication with a first base station performs a handover to a neighbor base station, the neighbor base station must first acquire the uplink pilot signal of the mobile station. To acquire the uplink pilot, the neighbor base station must search a timing range equal to the round-trip delay of the farthest point from which a mobile station can perform a handover to the neighbor base station, which is a function of the coverage area of the neighbor base station. With quasi-synchronous deployment, this search space is substantially reduced.

A further advantage of quasi-synchronous operation is that quasi-synchronous operation reduces the search time in inter-frequency handover. For inter-frequency handover searching, the mobile station has to retune its synthesizers, tune to a new radio frequency channel and search for the desired signal. In the course of this process, the mobile station may be temporarily out of communication with the base station. The WCDMA standard avoids data loss during this time by transmitting data at a higher data rate when the communication link is re-acquired.

Such high data rate transmissions significantly reduce the system capacity. The reduced search times provided by quasi-synchronous operation reduce the time that the mobile station is temporarily out of communication with the base station, and consequently reduce the amount of data that is transmitted at a higher data rate. In this way, quasi-synchronous operation enhances the system capacity by reducing the need for high data rate transmissions.

An additional advantage of quasi-synchronous operation is that it represents an enhancement to the performance of asynchronous operation without serious drawbacks. In other words, there is no technical disadvantage to quasi-synchronizing base stations. If the timing-related benefits associated with quasi-synchronous operation were to be unavailable for some reason, the system could operate in asynchronous mode. A loss of quasi-synchronization can be communicated to neighboring base stations and broadcast to mobile stations, which can then operate as they would in an asynchronous system.

Various embodiments of the invention have been described. Many of the methods described above may be implemented as machine readable instructions are capable of governing a function of a hardware device, which may be stored on a digital signal storage medium and which may be executed by a digital signal processing apparatus. These and other embodiments are within the scope of the following claims.

1. In a WCDMA system including a radio network controller for controlling a plurality of base stations in communication with at least one mobile station, a method comprising:
receiving a first time difference, the first time difference corresponding to the difference in time of receipt at the mobile station of a downlink signal transmitted from each of at least a first base station and a second base station;
generating a relative time difference as a function of at least the first time difference; and
broadcasting the relative time difference by at least one of the first and second base stations.

2. The method of claim 1, further comprising:
measuring, at the first and second base stations, a round trip delay for the downlink signal and an associated uplink signal,
the relative time difference is further a function of the round trip delays.

3. The method of claim 2, wherein measuring a round trip delay at the first base station comprises:
measuring a first delay for a downlink signal transmitted from the first base station and an uplink signal to the first base station; and
subtracting a known time delay from the first delay.

4. The method of claim 1, further comprising:
receiving a second time difference, the second time difference corresponding to the difference in time of receipt at a second mobile station of a second downlink signal transmitted from each of at least the first and second base stations,
wherein the relative time difference is a function of the first time difference and the second time difference.

5. The method of claim 1, further comprising:
receiving a second time difference, the second time difference corresponding to the difference in time of receipt at a second mobile station of a second downlink signal transmitted from the first base station and a third base station
generating a second relative time difference as a function of at least the second time difference; and
broadcasting the second relative time difference by at least one of the first and third base stations.

6. A digital signal storage medium embodying machine readable instructions executable by a digital signal processing apparatus in a WCDMA system, wherein the machine readable instructions are capable of governing a function of a hardware device, and wherein said machine readable instructions cause a hardware device to:
receive a first time difference, the first time difference corresponding to the difference in time of receipt at a mobile station of a downlink signal transmitted from each of at least a first base station and a second base station;
generate a relative time difference as a function of at least the first time difference; and
broadcast a relative time difference by at least one of the first and second base stations.

7. The medium of claim 6, the machine readable instructions further causing a hardware device to:
measure, at the first and second base stations, a round trip delay for the downlink signal transmitted and an associated uplink signal,
wherein the relative time difference is a function of the first time difference, the second time difference and the round trip delay.

8. The medium of claim 7, wherein measuring a round trip delay at the first base station comprises:
measuring a first delay for a downlink signal transmitted from the first base station and an uplink signal to the first base station; and
subtracting a known time delay from the first delay.

9. The medium of claim 6, the machine readable instructions further causing a hardware device to:
receive a second time difference, the second time difference corresponding to the difference in time of receipt at a second mobile station of a second downlink signal transmitted from each of at least the first and second base stations,
wherein the relative time difference is a function of the first time difference and the second time difference.

10. The medium of claim 6, the machine readable instructions further causing a hardware device to:
receive a second time difference, the second time difference corresponding to the difference in time of receipt at a second mobile station of a second downlink signal transmitted from the first base station and a third base station;
generate a second relative time difference as a function of at least the second time difference; and
broadcast a second relative time difference by at least one of the first and third base stations.

11. A wideband code division multiple access system comprising:
a first base station that uses a first time reference;
a second base station that uses a second time reference; and
a controller that computes a relative time difference as a function of the difference in time of receipt at a mobile station of a downlink signal transmitted from each of at least the first base station and the second base station.

12. The system of claim 11, wherein the controller further:
measures, at the first and second base stations, a round trip delay for the downlink signal and an associated uplink signal; and
calculates the relative time difference as a function of the round trip delays.

13. A wideband code division multiple access system comprising:
a first base station that communicates with a mobile station;
a second base station that communicates with the mobile station; and
a controller,
wherein the controller measures, at the first and second base stations, a round trip delay for the downlink signal and an associated uplink signal,
wherein the controller receives from the mobile station a first time difference, the first time difference corresponding to the difference in time of receipt at the mobile station of a downlink signal transmitted from each of at least a first base station and a second base station,
wherein the controller computes a relative time difference as a function of the measured round trip delays and the first time difference, and
wherein at least one of the first base station and the second base station broadcasts the relative time difference.

14. The system of claim 13,
wherein the first base station uses a first time reference,
wherein the second base station uses a second time reference,
wherein the relative time difference is a function of the difference between the first time reference and the second time reference.

15. A method comprising:
receiving a relative time difference transmitted by a first base station in a wideband code division multiple access system, the relative time difference being a function of the difference between a first time reference used by the first base station and a second time reference used by a second base station;
receiving from the first base station the first time reference used by a first base station; and
calculating the frame timing of the second base station as a function of the first time reference and the relative time difference.

16. The method of claim 15, further comprising acquiring frame timing of the second base station.

17. The method of claim 15, further comprising:
receiving a downlink signal transmitted from the first base station;
receiving the downlink signal transmitted from the second base station;
transmitting a first time difference, the first time difference corresponding to the difference in time of receipt the downlink signal transmitted from each of the first base station and the second base station.

18. A digital signal storage medium embodying machine readable instructions executable by a digital signal processing apparatus, wherein the machine readable instructions are capable of governing a function of a hardware device, and wherein said machine readable instructions cause a hardware device to:
receive from a first base station in a wideband code division multiple access system a relative time difference, the relative time difference being a function of the difference between a first time reference used by the first base station and a second time reference used by a second base station;
receive from the first base station the first time reference used by a first base station; and
calculate the frame timing of the second base station as a function of the first time reference and the relative time difference.

19. The medium of claim 18, the machine readable instructions further causing a hardware device to acquire frame timing of the second base station.

20. The medium of claim 18, the machine readable instructions further causing a hardware device to:
receive a downlink signal transmitted from the first base station;
receive the downlink signal transmitted from the second base station;
transmit a first time difference, the first time difference corresponding to the difference in time of receipt the downlink signal transmitted from each of the first base station and the second base station.
